(19) United States
(12) Patent Application Publication
(10) Pub. No.: US 2013/0083872 A1
(43) Pub. Date: Apr. 4, 2013

(54) METHOD FOR COHERENT AND NON COHERENT DEMODULATION

(71) Applicant: Anubala Varikat, Veloor (IN)

(72) Inventor: Anubala Varikat, Veloor (IN)

(21) Appl. No.: 13/344,884

(22) Filed: Jan. 6, 2012

(30) Foreign Application Priority Data
Oct. 1, 2011 (IN) 3409/CHE/2011

(51) Int. Cl. H04L 27/06

(52) U.S. Cl. 375/341; 375/344

(57) ABSTRACT

Methods for coherent and non-coherent demodulation are disclosed. Embodiments herein relate to wireless communication systems, and more particularly, to demodulating block orthogonal codes in wireless communication systems. Coherent detection of signals provides improved performance at higher complexity of implementation, but it can be difficult to keep the frequency errors in a wireless communications receiver within the required limits for coherent detection. Embodiments disclosed enable means of using coherent demodulation for block orthogonal codes in the presence of high frequency errors, through the use of techniques of frequency prediction, estimation and correction. Further, it enables a low complexity frequency estimator which provides high estimation range and accuracy.

The present application is based on, and claims priority from, IN Application Number 3409/CHE/2011, filed 1, Oct. 2011, the disclosure of which is hereby incorporated by reference herein.

### TECHNICAL FIELD

Embodiments herein relate to wireless communication systems, and more particularly, to demodulating orthogonal codes in wireless communication systems.

### BACKGROUND

Two forms of signal detection are coherent, where phase information of the signal is used, and non-coherent, where it is not. Non-coherent schemes are useful in systems where training sequences are not present in the signal being received, thus making phase acquisition difficult.

When the phase can be acquired accurately, either by using a training sequence or in some other way, coherent schemes offer better detection performance than non-coherent schemes.

Orthogonal block codes, an example of which is Walsh codes, can be detected non-coherently. Schemes for coherent detection of such codes exist as well, which give improved performance at higher complexity of implementation. Many of these coherent schemes are iterative in some form.

A requirement for demodulating a signal is that the receiver's clock be synchronized to the transmitter's clock. Hence, before demodulation of data, the frequency of the carrier needs to be acquired. For coherent detection techniques, the frequency acquisition may need to be much more accurate than for non-coherent, so as to make accurate phase acquisition possible.

In realistic scenarios, due to Doppler, the inherent drift of the local oscillator, and the limitations of the frequency estimation and tracking, it can be difficult to keep the frequency drift within the required limits for coherent detection.

In addition, for efficient power management, the radio signal being received may be monitored only at fairly large intervals of time, with the receiver going to sleep in between. When this is the case, it is even more problematic to keep the frequency drift on wake-up within desired limits.

The aforementioned problems are further aggravated by operation at very low and sub-zero SNRs, as in the case of satellite communications.

Consider a communication system using a block orthogonal code for modulation. FIG. 1 is a block diagram illustrating prior-art for a coherent demodulator for orthogonal codes. FIG. 1 illustrates a stage of non-coherent detection, followed by a stage of phase estimation and correction, and then a stage of coherent detection.

The block transform 101 stage typically performs a Maximum Likelihood hard output detection of the transmitted codeword. For Walsh codes, the block transform would be a Hadamard transform.

Some of the code words are detected wrongly in the presence of noise, but the Signal to Noise Ratio (SNR) is assumed to be high enough for most of them to be detected correctly. In the second stage, the phase of the input signal is estimated with the detected code-words used as a reference signal. Typically, the phase estimation involves a correlation between the received signal and the reference signal.

The soft output decoder 105 in the third stage would typically be a MAP (Maximum a-Priori) decoder, and outputs soft bits to a decoder for an outer code, typically a convolutional code.

In a scheme as above, the assumption is that the carrier frequency acquisition has already been done, and is sufficiently accurate to facilitate the phase estimation and correction in the second stage, as well as the detection in both the first and third stages.

A well known method for frequency estimation is using quadratic interpolation between three Fourier coefficients. This is a method used to reduce the complexity of estimation over that of evaluating Fourier coefficients at a higher granularity. For this method, there is a tradeoff between the accuracy and the range of the estimation: the larger the number of samples over which the estimation is done, the higher the accuracy of estimates in noise, but the lower the frequency range over which the estimation can be done.

Suppose N samples of data are available. Let the variance of estimation for N samples with this kind of estimator be V, and let the range be R. But suppose the range required by the application is KR, for some number K. The most direct way of extending the range to KR may be to repeat the estimation K times, over K contiguous frequency blocks, so as to cover the required range. The complexity is high here.

Non-coherent demodulation performs poorer than coherent demodulation. Further, coherent demodulation requires accurate phase estimates, which can be obtained only if the frequency drift is small, or can be compensated for accurately.

In realistic scenarios, especially when power management necessitates an infrequent monitoring of the signal, it can be difficult to keep the frequency drift within the required limits for coherent demodulation.

Algorithms for use in many applications, for example, in mobile and hand-held wireless communication terminals, need to be highly computationally efficient.

### SUMMARY

One object of the embodiments herein is to enable selection of a demodulation technique based on the expected frequency drift or the time from the previous good frequency estimation.

Another object of the embodiments herein is to enable prediction of the frequency drift and correction of the frequency error before performing coherent demodulation.

Another object of the embodiments herein is to enable partial demodulation, followed by frequency estimation and correction and phase estimation and correction, further followed by full demodulation.

Another object of the embodiments herein is to enable non-coherent demodulation, Frequency estimation and correction, Phase estimation and correction followed by a coherent demodulation.

Another object of the embodiments herein is to enable non-coherent demodulation, decoding of an outer code, Frequency estimation and correction, Phase estimation and correction followed by a coherent demodulation, further followed by decoding of an outer code.

Another object of the embodiments herein is to enable selecting the segment size of the signal over which the phase is to be estimated.

Further, another object of the embodiments herein is to enable a low complexity frequency estimator which provides high estimation range and accuracy.

Accordingly the embodiments herein provide a method for demodulation of a received signal in a receiver in a wireless communication network, the method comprising obtaining maximum expected frequency offset of the received signal; comparing the maximum expected frequency offset to a pre-defined threshold; performing coherent demodulation on the received signal, if the maximum expected frequency offset is less than the threshold; and performing non-coherent demodulation on the received signal, if the maximum expected frequency offset is greater than the accuracy threshold.

Also, provided herein is a method for demodulation of a received signal in a receiver in a wireless communication network, the method comprising predicting the frequency drift that occurs between the time of reception of the received signal and the last good frequency estimate; performing a frequency correction of the received signal using the predicted frequency drift; and demodulating the received signal using coherent detection.

Provided herein is a method for demodulation of a received signal in a receiver in a wireless communication network, the method comprising performing a block transform on the received signal; obtaining the output of the transform; determining the most likely transmitted code word using Maximum Likelihood estimation; performing frequency estimation using the code word as a reference signal; correcting the frequency of the received signal using the frequency estimates; performing phase estimation using the code word as a reference signal; correcting the phase of the transformed signal using the phase estimates; performing a soft output decoding of the phase corrected signal.

Disclosed herein is a method for demodulation of a received signal in a receiver in a wireless communication network, the method comprising performing a block transform on the received signal; obtaining the output of the transform; determining the most likely transmitted code word using Maximum Likelihood estimation; performing frequency estimation using the code word as a reference signal; correcting the frequency of the received signal using the frequency estimates; performing phase estimation using the code word as a reference signal; correcting the frequency and phase of the transformed signal using the frequency and phase estimates; performing a soft output decoding of the phase corrected signal.

Also, disclosed herein is a method for demodulation of a received signal in a receiver in a wireless communication network, the method comprising performing non-coherent detection of the received signal; performing frequency estimation and correction of the received signal; performing phase estimation and correction of the received signal; and performing coherent detection of the estimated and corrected signal.

Disclosed herein is a receiver in a wireless communication network, the receiver comprising at least one means configured for obtaining the maximum expected frequency offset of a received signal; comparing the maximum expected frequency offset to a pre-defined threshold; performing coherent demodulation on the received signal, if the maximum expected frequency offset is less than the threshold; and performing non-coherent demodulation on the received signal, if the maximum expected frequency offset is greater than the threshold.

Disclosed herein is a receiver in a wireless communication network, the receiver comprising at least one means configured for predicting the frequency drift incurred between the time of reception of a received signal and the last good frequency estimate; performing a frequency correction of the received signal using the predicted frequency drift; and demodulating the received signal using coherent detection.

Disclosed herein is a receiver in a wireless communication network, the receiver comprising at least one means configured for performing non-coherent detection of a received signal; performing frequency estimation and correction of the received signal; performing phase estimation and correction of the received signal; and performing coherent detection of the corrected signal.

Disclosed herein is a receiver in a wireless communication network, the receiver including a plurality of frequency estimation and correction modules, wherein the modules are cascaded.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the drawings, in which:

FIG. 1 is a block diagram illustrating a coherent demodulator for orthogonal codes, according to prior-art;

FIG. 2 is a block diagram illustrating the technique of switching between coherent and non-coherent modulation, according to embodiments as disclosed herein;

FIG. 3 is a flow chart depicting the process of switching between a coherent and a non-coherent modulation, according to embodiments as disclosed herein;

FIG. 4 is a flow chart depicting the process of predicting frequency drift for a coherent modulation, according to embodiments as disclosed herein;

FIG. 5 is a block diagram illustrating coherent demodulation, according to embodiments as disclosed herein;

FIG. 6 is a block diagram illustrating the frequency and phase estimation and correction unit for coherent demodulation with phase correction, according to embodiments as disclosed herein;

FIG. 7 is a flow chart illustrating the process of coherent demodulation with phase correction, according to embodiments as disclosed herein;

FIG. 8 is a block diagram illustrating the frequency and phase estimation and correction unit for coherent demodulation with phase and frequency correction, according to embodiments as disclosed herein;

FIG. 9 is a flow chart illustrating the process of coherent demodulation with frequency and phase correction, according to embodiments as disclosed herein;

FIG. 10 is a block diagram illustrating coherent demodulation with phase and frequency correction with two iterations of the Block transformation, according to embodiments as disclosed herein;

FIG. 11 is a flow chart illustrating the process of coherent demodulation with frequency and phase correction, and two iterations of the Block transformation, according to embodiments as disclosed herein;

FIG. 12 is a block diagram illustrating iterative detection, with a stage of non-coherent detection followed by a stage of coherent detection, according to embodiments as disclosed herein;

FIG. 13 is a block diagram illustrating non-coherent detection, according to embodiments as disclosed herein;

FIG. 14 is a block diagram illustrating coherent detection, according to embodiments as disclosed herein;

FIG. 15 is a flow chart illustrating the process of iterative detection, according to embodiments as disclosed herein;

FIG. 16 is a block diagram illustrating iterative decoding, according to embodiments as disclosed herein;

FIG. 17 is a block diagram illustrating coherent detection for iterative decoding, according to embodiments as disclosed herein;

FIG. 18 is a flow chart illustrating the process of iterative decoding, according to embodiments as disclosed herein;

FIG. 19 is a block diagram of a low complexity and high accuracy frequency estimator, according to embodiments as disclosed herein;

FIG. 20 is a block diagram illustrating the architecture of a low complexity and high accuracy frequency estimation and correction unit, according to embodiments as disclosed herein; and

FIG. 21 is a flow chart illustrating the process of low complexity and high accuracy frequency estimation, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

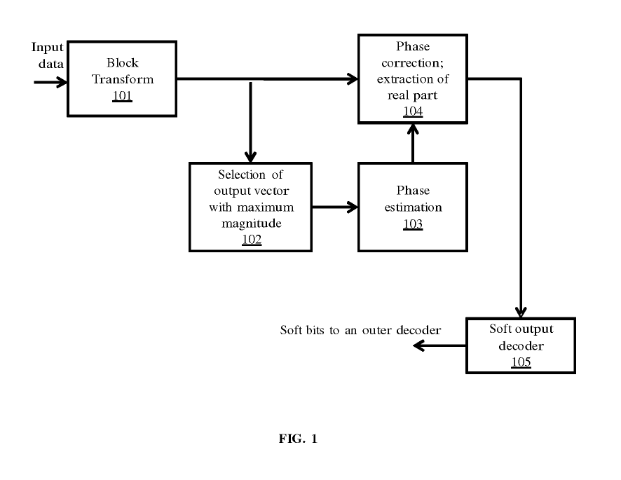

The embodiments herein achieve a method for coherent demodulation and for a combination of coherent and non-coherent demodulation. In realistic scenarios, the schemes give significant performance improvement over non-coherent demodulation. The schemes are useful when, due to frequency drift, it is not possible to do an accurate phase estimation using a scheme like that of the coherent demodulator depicted in FIG. 1.

The schemes are intended for codes that have been designed such that the period over which a code word is spread, is small enough for the phase to remain coherent over it, for the maximum expected frequency offset. The schemes may be extended to work with codes that are not designed in this fashion.

The scenario being addressed is one where, at even moderate frequency offsets, and at the low SNRs being used, the phase does not cohere over a sufficiently long period to allow accurate phase estimation.

Referring now to the drawings, and more particularly to FIGS. 1 through 21, where similar reference characters denote corresponding features consistently throughout the figures, there are shown preferred embodiments.

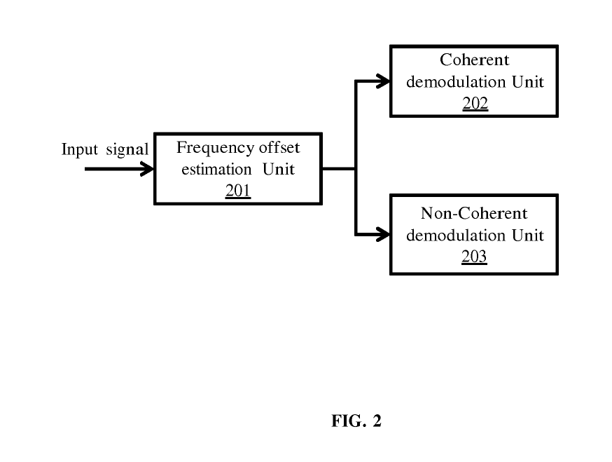

FIG. 2 is a block diagram illustrating switching between coherent and non-coherent modulation schemes, according to embodiments as disclosed herein. The receiver comprises a frequency estimation unit 201, a coherent de-modulation unit 202 and a non-coherent demodulation unit 203. Input data may be received by the frequency offset estimation unit 201. The frequency offset estimation unit 201 may estimate the maximum expected frequency offset between the carrier of the received signal and a local clock. Further, based on the estimated maximum expected frequency offset, the data can be transferred to the coherent demodulation unit 202 or the non-coherent demodulation unit 203 to perform one of either coherent demodulation or non-coherent demodulation.

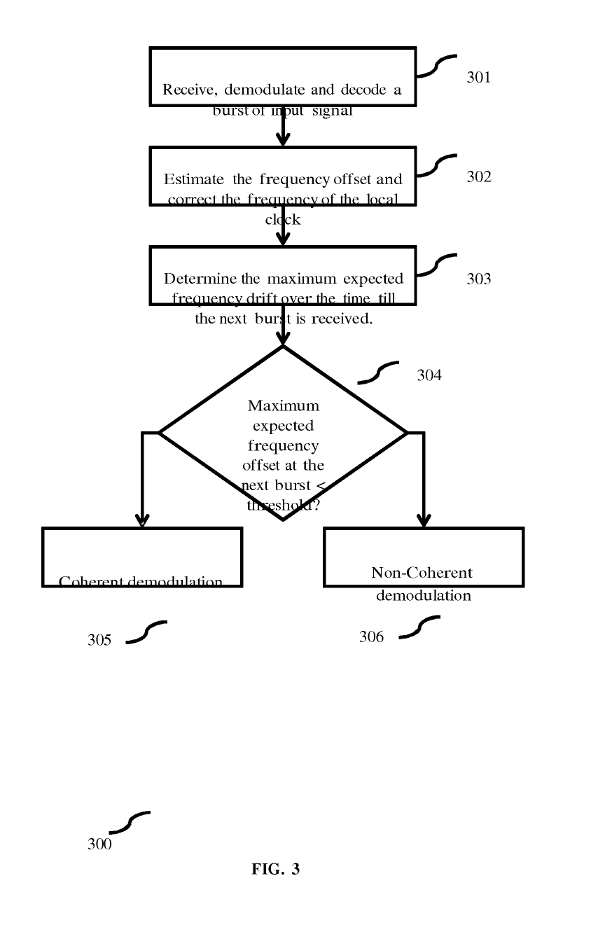

FIG. 3 is a flow chart depicting the process of switching between coherent and non-coherent modulation schemes, according to embodiments as disclosed herein. The frequency offset estimation unit 201 receives (301) bursts of input data, separated by known intervals of time. The frequency offset estimation unit 201 estimates (302) the frequency offset of a burst of data. In one embodiment, the frequency estimation may be carried out by demodulating a burst, converting the demodulated soft bits to hard bits, re-modulating the hard bits, and using the re-modulated signal as a reference signal for determining the frequency offset of the received signal. In another embodiment, the frequency estimation may be carried out by demodulating and decoding a burst, re-encoding and re-modulating the decoded bits, and using this re-built signal as a reference signal for determining the frequency offset of the received signal. The frequency offset estimation unit 201 may also determine (303) the expected frequency drift between two bursts and the maximum expected frequency offset for the next received burst. The maximum expected frequency offset may be determined based on the accuracy of the frequency estimation and on the maximum expected frequency drift during the elapsed time between the previous good estimate and the arrival of the present burst. For example, the elapsed time may be the time interval between bursts of received signals which may occur due to the bursty nature of the transmitted signal, due to intermittent decode failures leading to failure of frequency estimation or due to the system going into sleep mode or hibernating in that time period. Based on the maximum expected frequency offset, the frequency offset estimation unit 201 decides (304) if coherent demodulation or non-coherent demodulation is to be performed by comparing the maximum expected frequency offset against a pre-defined threshold. If the maximum expected frequency offset is less than the threshold, then the frequency offset estimation unit 201 sends the received signal to the coherent demodulation unit 202, which performs (305) coherent demodulation. If the maximum expected frequency offset is greater than the threshold, then the frequency offset estimation unit 201 sends the received signal to the non-coherent demodulation unit 202, which performs (306) non-coherent demodulation. The various actions in the method 300 may be performed in the order presented, in a different order or simultaneously. Further, in some embodiments, some actions listed in FIG. 3 may be omitted.

In a preferred embodiment, the elapsed time is small from the previous good estimate to the present reception, leading to lower frequency drift. A lower elapsed time may be used as the criterion to enable coherent demodulation thereby providing a means to recover a signal arriving at a low SNR. For example, coherent demodulation may give an improvement of 1.8 dB in bit error rate (BER) performance, over non-coherent demodulation in a fading channel.

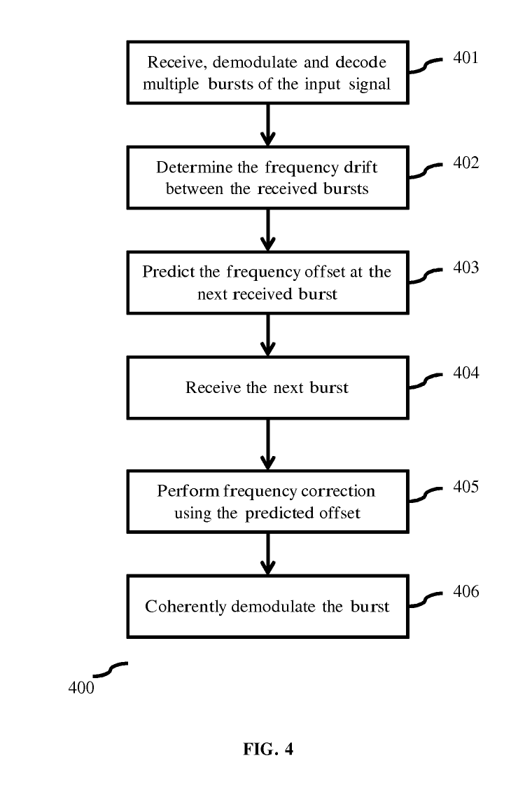

FIG. 4 is a flow chart depicting the process to predict the frequency offset of a burst arriving at a future point in time, and to correct it's frequency on reception, according to embodiments as disclosed herein. The signal may be observed (401) over a period of time to measure (402) the frequency drift over a number of bursts. The frequency of the received signal may be estimated during the periods when the receiving terminal monitors the arriving signal (401). In one embodiment, the frequency estimation may be carried out by demodulating a burst, converting the demodulated soft bits to hard bits, re-modulating the hard bits, and using the re-modulated signal as a reference signal for determining the frequency offset of the received signal. In another embodiment, the frequency estimation may be carried out by demodulating and decoding a burst, re-encoding and re-modulating the decoded bits, and using this re-built signal as a reference signal for determining the frequency offset of the received signal. The frequency drift during the interval between the burst to be demodulated and the last good frequency estimation can be predicted (403) based on the measured frequency drift between previous bursts and the estimated frequency of a previous burst. Further, frequency correction of the burst may be performed (405) using the predicted value. Furthermore, the burst may be coherently demodulated (406). The various actions in the method 400 may be performed in the order presented, in a different order or simultaneously. Further, in some embodiments, some actions listed in FIG. 4 may be omitted.

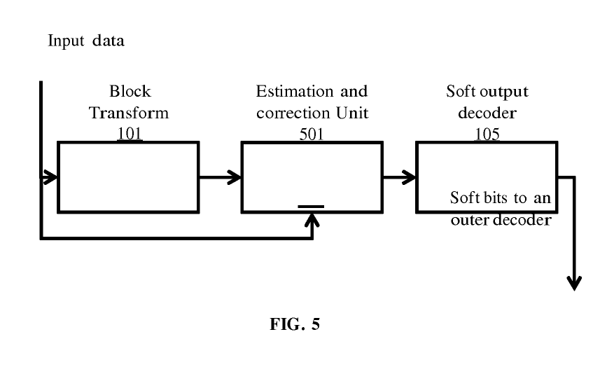

FIG. 5 is a block diagram illustrating coherent demodulation, according to embodiments as disclosed herein. The first stage of the demodulation may be a Block transform 101. The Block transform 101 may perform a Maximum Likelihood hard output detection of the transmitted codeword. For example, if the received signal is Walsh encoded, the block transform may perform a Hadamard transform. The transformed signal may be transmitted to the frequency and phase estimation and correction unit 501. The output of the estimation and correction unit 501 may be passed to a soft output decoder 105. The soft output decoder 105 may be a MAP (Maximum A-Priori) decoder. The soft output decoder 105 outputs soft bits to a decoder for an outer code, typically a convolutional code used for Channel Coding.

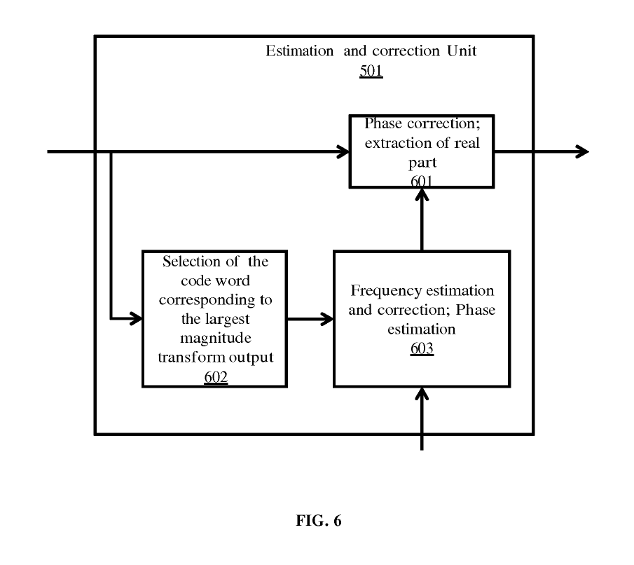

FIG. 6 is a block diagram illustrating the frequency and phase estimation and correction unit for coherent demodulation with phase correction, according to embodiments as disclosed herein. The Hadamard transformation operation may be seen as the multiplication of a column vector, comprising the samples of the input signal, with a Hadamard matrix, to give a transformed column vector at the output, comprising the elements of the transformed signal. Both the input and output column vectors contain complex elements, in accordance with the mathematical representation of a radio communications signal in the baseband. The transformed signal vector may be transmitted to the Phase correction unit 601 and the largest transform output unit 602. The largest transform output unit 602 identifies the element of the transform output vector with the maximum magnitude. Further, it identifies the row of the Hadamard matrix by multiplication of which with the input vector this element is produced. The row vector corresponds to the most likely transmitted code word. It can be used as a reference signal to estimate the frequency offset of the received signal. The code word may be transmitted to the frequency estimation and correction and phase estimation unit 603. The frequency estimation and correction is carried out so as to enable accurate phase estimation over a large block of received samples comprising more than one code word. Further, the frequency estimation can be performed by comparing the received signal with a reference signal consisting of the row vector of the Hadamard matrix producing the largest magnitude output element. The frequency estimation can be performed on a block of received samples comprising a number of code words. Further, the frequency estimate obtained is used to correct the frequency of the received signal. Further, the phase of the code words is estimated. Furthermore, the output of the frequency estimation and correction and phase estimation unit 603 may be provided to the phase correction unit 601. The Phase correction unit 601 may correct the phase of the signal received from the Block transform 101, extracts the real part of the complex signal, and gives an output which may be provided to the soft output decoder 105.

In an embodiment, the phase drift over the spread of a code-word may not be large but frequency correction may be essential for accurate phase estimation over multiple code-words.

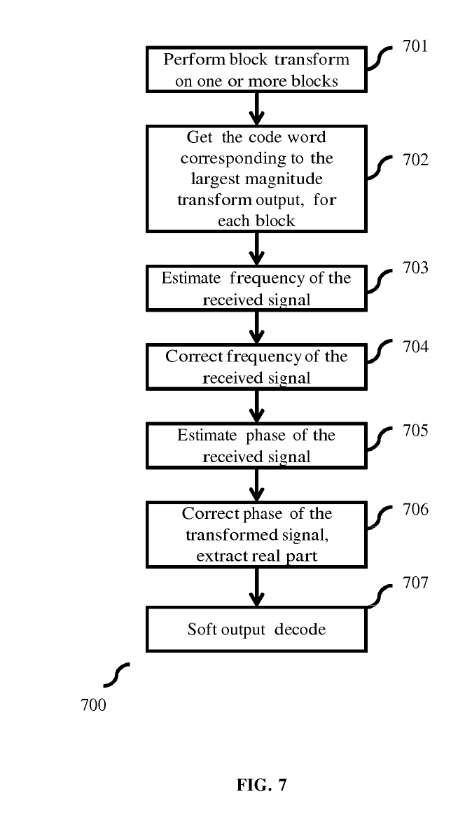

FIG. 7 is a flow chart illustrating the process of coherent demodulation with phase correction, according to embodiments as disclosed herein. Block transform 101 may transform (701) the input signal in order to get transformed signal outputs. The Hadamard transformation operation may be seen as the multiplication of a column vector, comprising the samples of the input signal, with a Hadamard matrix, to give a transformed column vector at the output, comprising the elements of the transformed signal. The transformed signal vector may be transmitted to the largest transform output unit to identify the element of the transform output vector with the maximum magnitude (702). Further, it identifies the row of the Hadamard matrix by multiplication of which with the input vector this element is produced. The row vector corresponds to the most likely transmitted code word. It can be used as a reference signal to estimate the frequency offset of the received signal. The code word may be transmitted to the frequency estimation and correction and phase estimation unit. Further, the frequency estimation (703) and correction (704) can be performed on the received signal in order to estimate the phase of the signal (705). Furthermore, the phase estimate may be provided to the phase correction unit for phase correction of the transformed signal (706). The real part of the Phase corrected signals is extracted and may be decoded using a soft-output MAP decoder to generate (707) the output containing soft information about a bit's value. The various actions in the method 700 may be performed in the order presented, in a different order or simultaneously. Further, in some embodiments, some actions listed in FIG. 7 may be omitted.

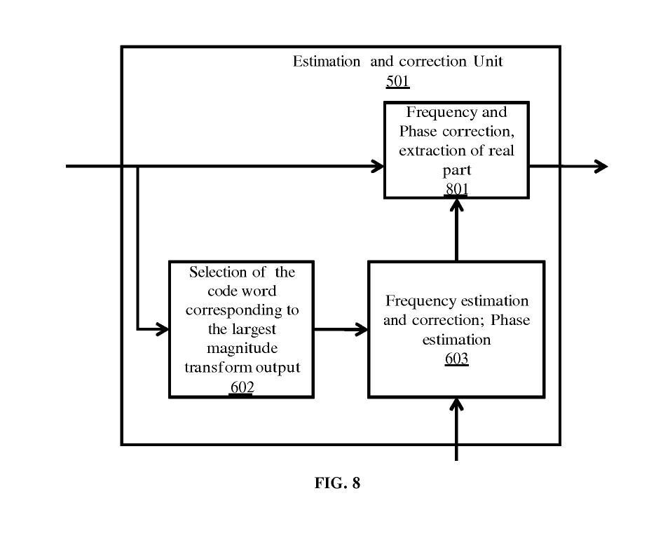

FIG. 8 is a block diagram illustrating the estimation and correction unit for coherent demodulation with phase and frequency correction, according to embodiments as disclosed herein. In another embodiment, the transformed signals may be transmitted to the Frequency and Phase correction unit 801 and the largest transform output unit 602. The Hadamard transformation operation may be seen as the multiplication of a column vector, comprising the samples of the input signal, with a Hadamard matrix, to give a transformed column vector at the output, comprising the elements of the transformed signal. The transformed signal vector may be transmitted to the Phase correction unit 601 and the largest transform output unit 602. The largest transform output unit 602 identifies the element of the transform output vector with the maximum magnitude. Further, it identifies the row of the Hadamard matrix by multiplication of which with the input vector this element is produced. The row vector corresponds to the most likely transmitted code word. It can be used as a reference signal to estimate the frequency offset and phase of the received signal. The code word may be transmitted to the frequency estimation and correction and phase estimation unit 603. Further, the frequency estimation and correction can be performed on the received signal in order to estimate the phase of the signal. Furthermore, the output of the frequency estimation and correction unit 603 may be provided to the Frequency and Phase correction unit 801. The Frequency and Phase correction unit 801 may correct the frequency and phase of the signal received from the Block transform 101, extract the real part and give an output which may be provided to the soft output decoder 105.

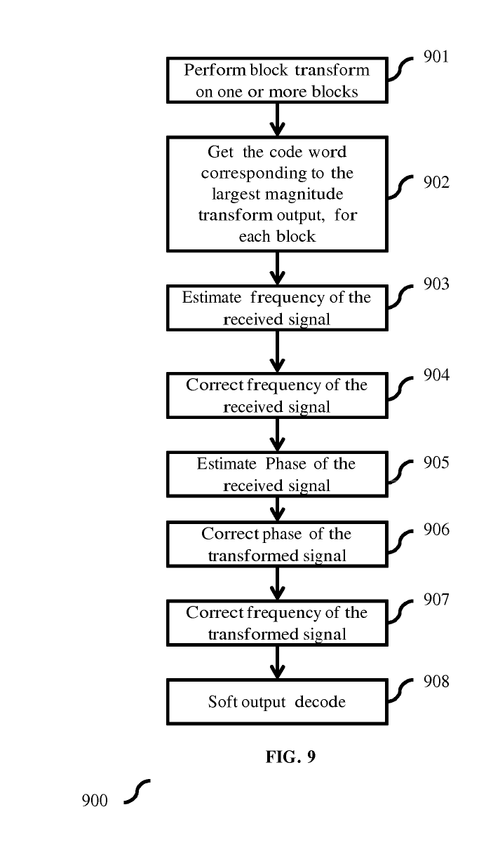

FIG. 9 is a flow chart illustrating the process of coherent demodulation with frequency and phase correction, according to embodiments as disclosed herein. Block transform 101 may transform (901) the input signal in order to get transformed signal outputs. The Hadamard transformation operation may be seen as the multiplication of a column vector, comprising the samples of the input signal, with a Hadamard matrix, to give a transformed column vector at the output, comprising the elements of the transformed signal. The transformed signal vector may be transmitted to the largest transform output unit to identify the element of the transform output vector with the maximum magnitude (902). Further, it identifies the row of the Hadamard matrix by multiplication of which with the input vector this element is produced. The row vector corresponds to the most likely transmitted code word. It can be used as a reference signal to estimate the frequency offset of the received signal. The code word may be transmitted to the frequency estimation and correction and phase estimation unit. Further, the frequency estimation (903) and correction (904) can be performed on the received signal in order to estimate the phase of the signal (905). Furthermore, the frequency and phase estimates may be provided to the frequency and phase correction unit for frequency (906) and phase (907) correction of the transformed signal. The frequency and phase corrected signals may be decoded to generate (908) soft information output about a bit's value. The various actions in the method 900 may be performed in the order presented, in a different order or simultaneously. Further, in some embodiments, some actions listed in FIG. 9 may be omitted.

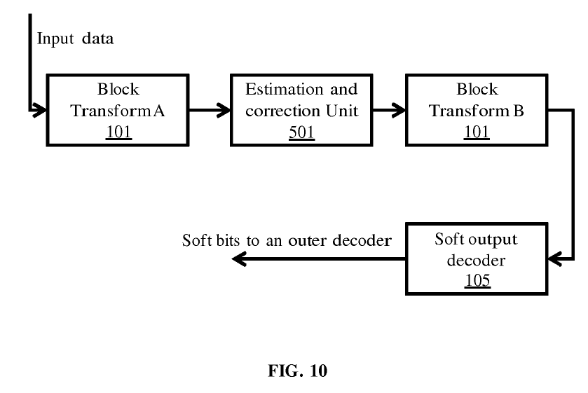

FIG. 10 is a block diagram illustrating coherent demodulation with phase and frequency correction with two iterations of the Block transformation, according to embodiments as disclosed herein. In another embodiment, the input signals may be received by a Block transform A 101. Block transform A 101 may perform a Maximum Likelihood hard output detection of the transmitted codeword. For example, if Walsh codes are detected, the block transform may perform a Hadamard transform. The transformed signal may be transmitted to the estimation and correction unit 401. The frequency and phase corrected signal may be transmitted to a second Block transform B. Further, the output of Block transform B 101 may be passed to soft output decoder 105. The soft output decoder 105 may be a MAP decoder. The soft output decoder 105 outputs soft bits to a decoder for an outer code, typically a convolutional code. The generated soft bits information may be transmitted to an outer decoder for further decoding of the symbols.

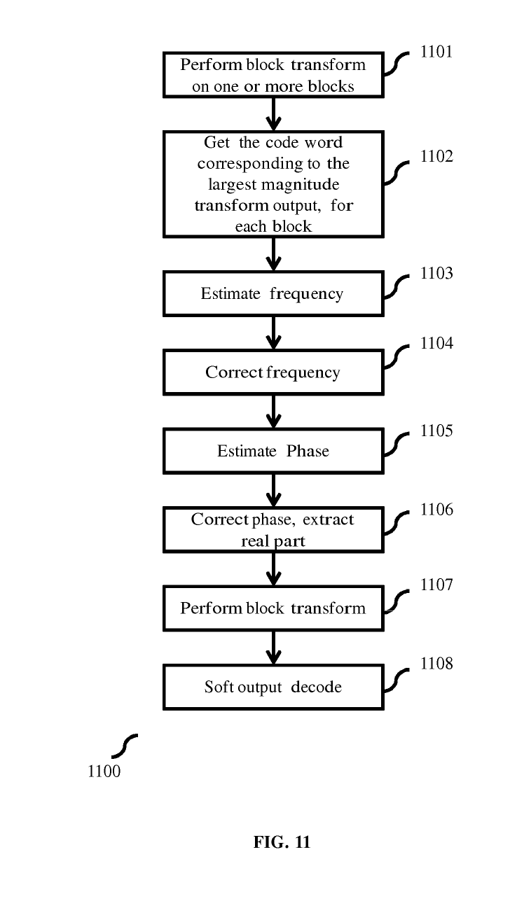

FIG. 11 is a flow chart illustrating the process of coherent demodulation with frequency and phase correction, with two iterations of the Block transformation, according to embodiments as disclosed herein. Block transform A 101 may transform (1101) the input signal. The Hadamard transformation operation may be seen as the multiplication of a column vector, comprising the samples of the input signal, with a Hadamard matrix, to give a transformed column vector at the output, comprising the elements of the transformed signal. The transformed signal vector may be transmitted to the largest transform output unit to identify the element of the transform output vector with the maximum magnitude (1102). Further, it identifies the row of the Hadamard matrix by multiplication of which with the input vector this element is produced. The row vector corresponds to the most likely transmitted code word. It can be used as a reference signal to estimate the frequency offset of the received signal. The code word may be transmitted to the frequency estimation unit. The frequency of the signal may be estimated (1103) by using the reference signal. Further, the estimated frequency of the received signal may be corrected (1104) in order to estimate (1105) phase of the signal. Further, the phase of the signal may be corrected (1106) and the real part extracted. 101. Furthermore, Block transform B 101 may perform a second transformation (1107) on the real part of the frequency and Phase corrected signal. The transformed signal may be decoded (1108) using a MAP decoder to generate soft information output about a bit's value. The various actions in the method 1100 may be performed in the order presented, in a different order or simultaneously. Further, in some embodiments, some actions listed in FIG. 11 may be omitted.

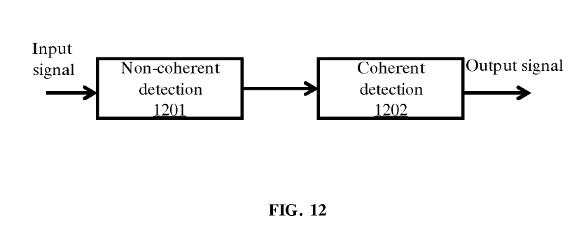

FIG. 12 is a block diagram illustrating iterative detection, according to embodiments as disclosed herein. A non-coherent detection unit 1201 may receive input signals. The non-coherent detector does not require knowledge of the carrier phase of the input signal. The output of the non-coherent detection unit 1201 may be transmitted to the frequency estimation and correction unit 603. In one embodiment, the frequency estimation may be carried out by demodulating a burst, converting the demodulated soft bits to hard bits, re-modulating the hard bits, and using the re-modulated signal as a reference signal for determining the frequency offset of the received signal. The output of the frequency estimation and correction unit 603 may be passed to the coherent detection unit 1202.

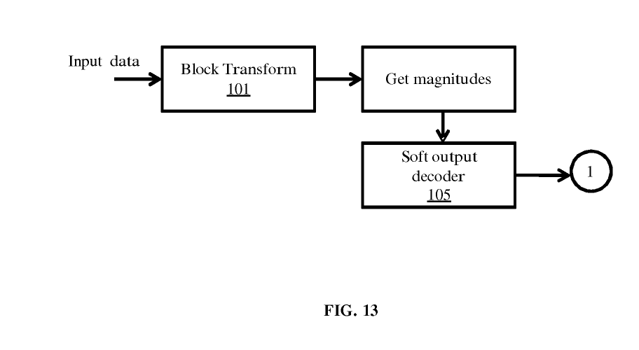

FIG. 13 is a block diagram illustrating non-coherent detection, according to embodiments as disclosed herein. The input signal may be passed to a Block transform 101. Block transform 101 may perform a Maximum Likelihood hard output detection of the transmitted codeword. For example, if Walsh codes are detected, the block transform may perform a Hadamard transform. The magnitudes of the transformed signal may be obtained and transmitted to a soft output decoder 105. The soft output decoder 105 may be a MAP decoder. The soft output decoder 105 outputs soft bits to a decoder for an outer code, typically a convolutional code. The generated soft bits information may be converted to hard bits. The hard bits may be re-modulated using the same procedure which may be used in the transmitter for modulating the data. Further, the frequency estimation and correction may be performed using the re-modulated burst as a reference signal.

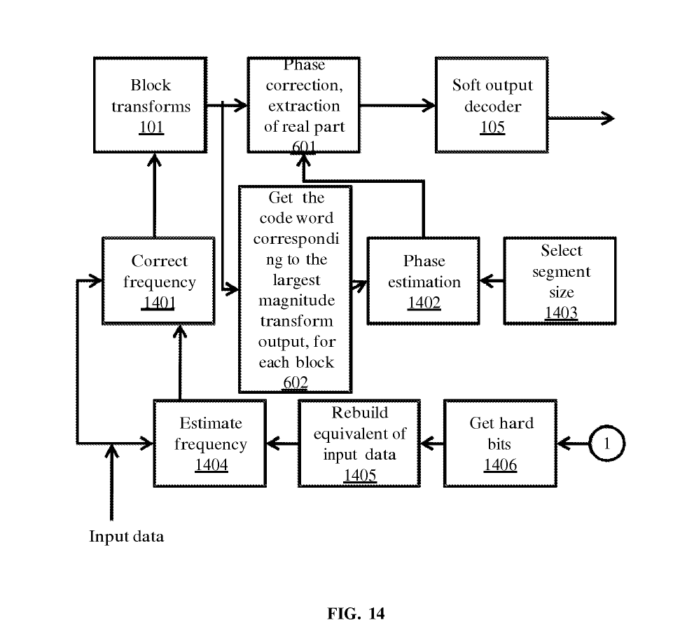

FIG. 14 is a block diagram illustrating coherent detection, according to embodiments as disclosed herein. The input data can be transmitted to the frequency correction unit 1401 and frequency estimation unit 1404. Further, the frequency corrected data from the non-coherent detector 1201 may be transmitted to coherent detector 1202 for detection. The hard bits can be received by the get hard bits unit 1406. The hard bits may be transmitted to rebuild equivalent of input data unit 1405. The rebuilt equivalent of input data unit 1405 generates a signal from the hard bits which may be equivalent to a noise-less version of the received input signal. Further, the estimate frequency unit 1404 may estimate frequency of the input data by using the generated signal and the received signal. The estimated frequency may be passed on to the correct frequency unit 1401. The correct frequency unit 1401 may correct the frequency offset of the signal and transfer the corrected signal to the Block transform 101 unit. The Block transform 101 may perform maximum likelihood hard output detection on the transmitted input signal. For example, if Walsh codes are detected, the block transform may perform a Hadamard transform. The transformed signals may be transmitted to Phase correction unit 601 and largest transform output unit 602. The largest transform output unit 602 identifies the most likely transmitted code-word. The code-word may be transmitted to the phase estimation unit 1402. The phase estimation unit 1402 may receive segment size value from a select segment size unit 1403. The segment size may be the size of signal segment on which phase estimation may be performed. The phase of the signal can be estimated using the code-word as a reference signal. Further, the output of phase estimation unit 1402 may be provided to the phase correction unit 601. The Phase correction unit 601 may correct the phase of the signal received from the Block transform, extract the real part 101 and give an output which may be provided to soft output decoder 105. The soft output decoder 105 may produces soft estimates of the code bits one dwell interval at a time. The soft output decoder 105 may be a MAP decoder. The soft output decoder 105 outputs soft bits to a decoder for an outer code, typically a convolutional code.

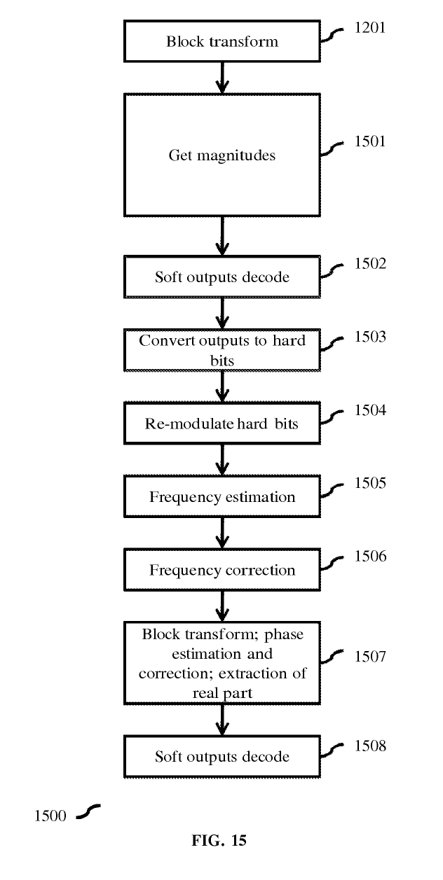

FIG. 15 is a flow chart illustrating the process of iterative detection, according to embodiments as disclosed herein. Block transform 101 may transform (1501) the input signal and produce transformed signals. The magnitudes of the transformed signal are obtained (1501). Soft output decoding (1502) is performed on the magnitudes. The soft bits are converted to hard bits (1503), and the hard bits are re-modulated to get a reference signal (1504). The frequency of the signal may be estimated (1505) by using the reference signal. Further, the estimated frequency may be used to correct the signal (1504) in order to estimate and correct the phase of the signal (1507). Further the real part of the phase-corrected signal is extracted. The real signals may be decoded to generate (1508) soft information as output about a bit's value. The various actions in the method 1500 may be performed in the order presented, in a different order or simultaneously. Further, in some embodiments, some actions listed in FIG. 15 may be omitted.

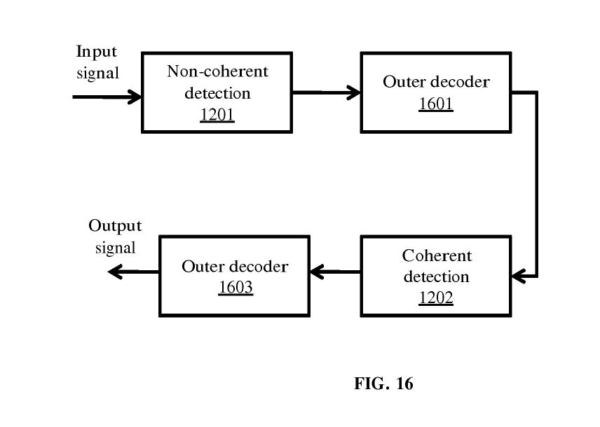

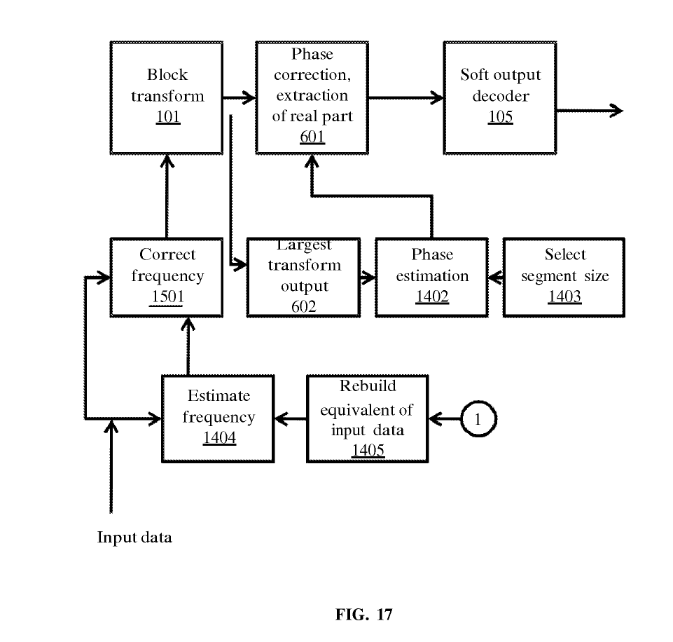

FIG. 16 is a block diagram illustrating iterative decoding, according to embodiments as disclosed herein. A non-coherent detection unit 1201 may receive input signals. The output of the non-coherent detection unit 1201 may be passed to the outer decoder 1601. The output of the outer decoder may be passed to the Coherent detection unit, where it may be re-encoded and re-modulated 1202. Since the decoded data will have fewer bits in error than the hard bits at the output of a demodulator or of a non-coherent or coherent detector, the re-encoded and re-modulated signal may serve as a better reference signal than the re-modulated signal in an earlier embodiment. Frequency and phase estimation and correction are performed using the signal as a reference. The frequency and phase corrected signal is coherently demodulated. The output of the coherent demodulator is transmitted to a second outer decoder 1603. The outer decoding can be performed once after the first stage of non-coherent detection and further after the second stage of coherent detection.

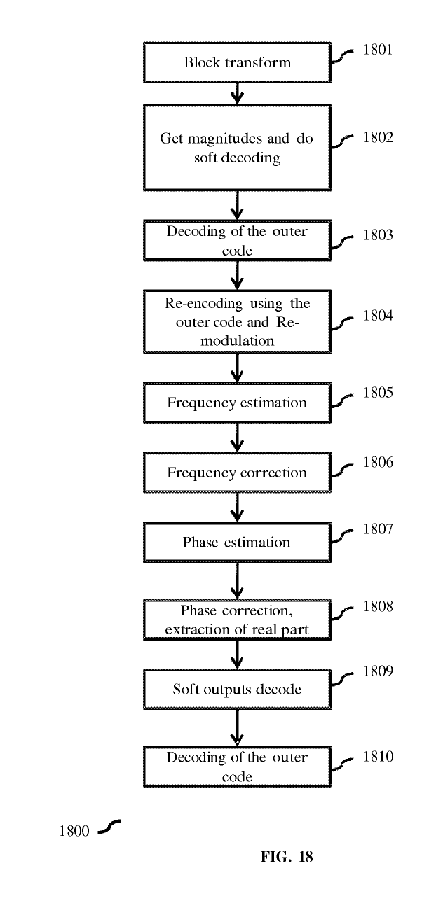

FIG. 17 is a block diagram illustrating coherent detection for iterative decoding, according to embodiments as disclosed herein. The input data can be transmitted to Block transform 101, correct frequency unit 1401 and estimate frequency unit 1404. Further, the frequency corrected data from the non-coherent detector 1201 may be transmitted to coherent detector 1202 for detection. The hard bits can be received by rebuild equivalent of input data unit 1405. The rebuild equivalent of input data unit 1405 generates a signal from the hard bits which may be equivalent to a noiseless version of the received input signal. Further, the estimate frequency unit 1404 may estimate frequency of the input data by using the generated signal. The estimation of frequency using the decoded bits leads to more accurate frequency estimates. The estimated frequency may be passed on to Block transform 101 and correct frequency unit 1401. The correct frequency unit 1401 may correct the frequency offset of the signal and transfer the correct frequency value to Block transform 101 unit. Block transform 101 may perform maximum likelihood hard output detection on the transmitted input signal. For example, if Walsh codes are detected, the block transform may perform a Hadamard transform. The transformed signals in frequency domain may be transmitted to Phase correction unit 601 and largest transform output unit 602. The largest transform output unit 602 identifies the most likely code words and captures them. The most likely code words may be used as a reference signal for frequency and phase estimation. The code word may be transmitted to Phase estimation unit 1402. The phase estimation unit 1402 may receive segment size value from a select segment size unit 1403. The segment size may be the size of signal segment on to which phase estimation may be performed. The phase of the signal can be estimated using the code words as a reference signal. Further, the output of the phase estimation unit 1402 may be provided to the phase correction unit 601. The Phase correction unit 601 may correct the phase of the signal received from the Block transform, extract the real part 101 and give an output which may be provided to the soft output decoder 105. The soft output decoder 105 may produce soft estimates of the code bits. The soft output decoder 105 may be a MAP decoder. The soft output decoder 105 outputs soft bits to a decoder for an outer code, typically a convolutional code. The soft output decoder 403 may generate information about a bit's value. The generated soft bits information may be transmitted to an outer decoder for further decoding of the symbols.

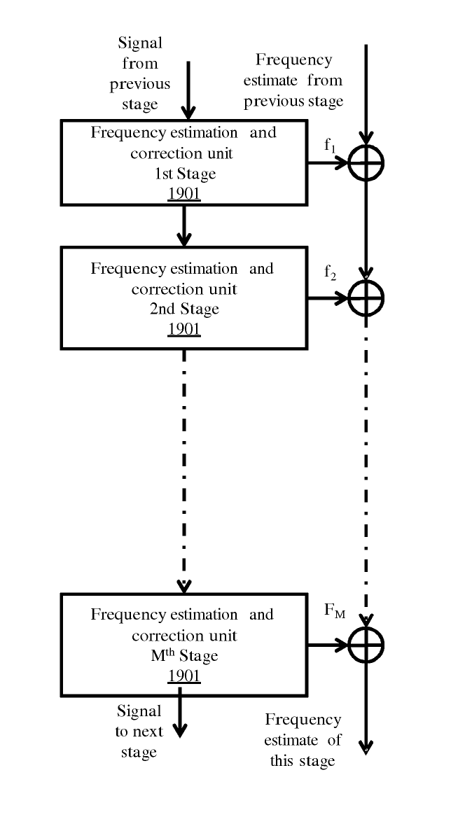

FIG. 18 is a flow chart illustrating the process of iterative decoding, according to embodiments as disclosed herein. Block transform 101 may transform (1801) the input signal in order to get a transformed signal output. The magnitudes of the output signal are decoded to get soft information about the bits. The soft bits are passed to the outer decoder for decoding of the outer code (1803), typically a convolutional code. The decoded signals may be re-encoded and re-modulated (1804). The re-encoded and re-modulated signal may be used as a reference signal to perform frequency estimation (1805). Further, the estimated frequency is used for frequency correction (1806) in order to estimate (1807) the phase of the signal. The estimated phase of the signal may be corrected, and the real part of the corrected signal is extracted. (1808). A soft-output decoding may be performed on the real part of the corrected signal. The various actions in the method 1800 may be performed in the order presented, in a different order or simultaneously. Further, in some embodiments, some actions listed in FIG. 18 may be omitted.

In an embodiment, the segment size for phase estimation may be selected to be as large as possible based on at least one or more factors such as expected error in frequency estimation, expected frequency drift, the time elapsed from the previous good frequency estimate, the iteration number and an estimate of the quality of the received or the demodulated signal which may be obtained by using received and the decoded bits. The segment size of the signal for phase estimation may be selected to be as large as possible. Better accuracy may be achieved if the estimation is performed over a larger segment size of the signal. Further, low error in frequency acquisition may enable larger segment size of signal over which the phase may remain coherent in order to estimate phase accurately.

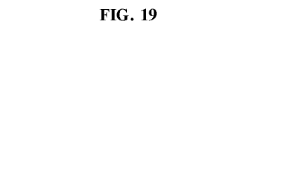

FIG. 19 is a block diagram of a low complexity and high accuracy frequency estimator, according to embodiments as disclosed herein. In an embodiment, cascaded stages of frequency estimation and correction units 1901 may be deployed in order to provide low complexity, high accuracy and high range. Signals from the previous stage may be received by the frequency estimation and correction unit 1901 wherein the frequency estimation and correction unit 1901 estimates the frequency offset of the received signal for the current stage and corrects the estimated frequency offset. Further, the frequency estimate and the corrected signal may be passed to the next frequency estimation and correction stage. Further, the frequency estimate from each stage may be added and the sum of frequency estimates from all the cascaded stages may be obtained after the frequency estimation and correction process. Each stage works on a higher segment size than the previous stage and as a result has higher accuracy and lower estimation range than the previous stage. The cascaded scheme has an estimation range equal to that of the first stage, and estimation accuracy equal to that of the final stage. The number of cascaded stages may be determined depending upon the degree of accuracy required.

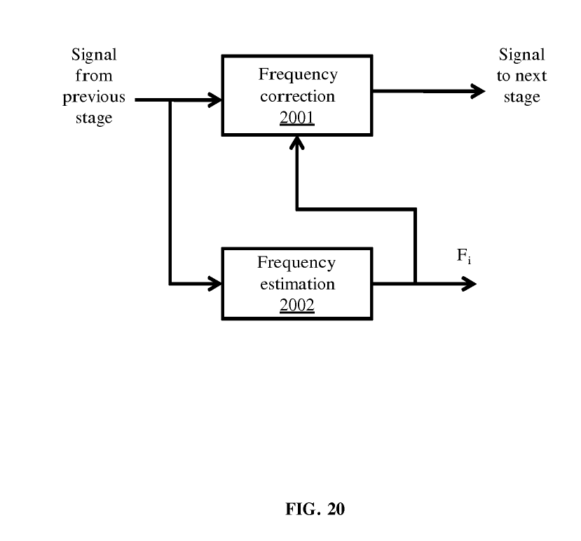

FIG. 20 is a block diagram illustrating the architecture of the frequency estimation and correction unit, according to embodiments as disclosed herein. The frequency estimation and correction unit may comprise a frequency correction unit 2001 and a frequency estimation unit 2002. Signals may be received by the frequency correction unit 2001 and the frequency estimation unit 2002. The frequency of the signal may be estimated by the frequency estimation unit 2002. Further, the signal frequency can be corrected using this estimate by the frequency correction unit 2001.

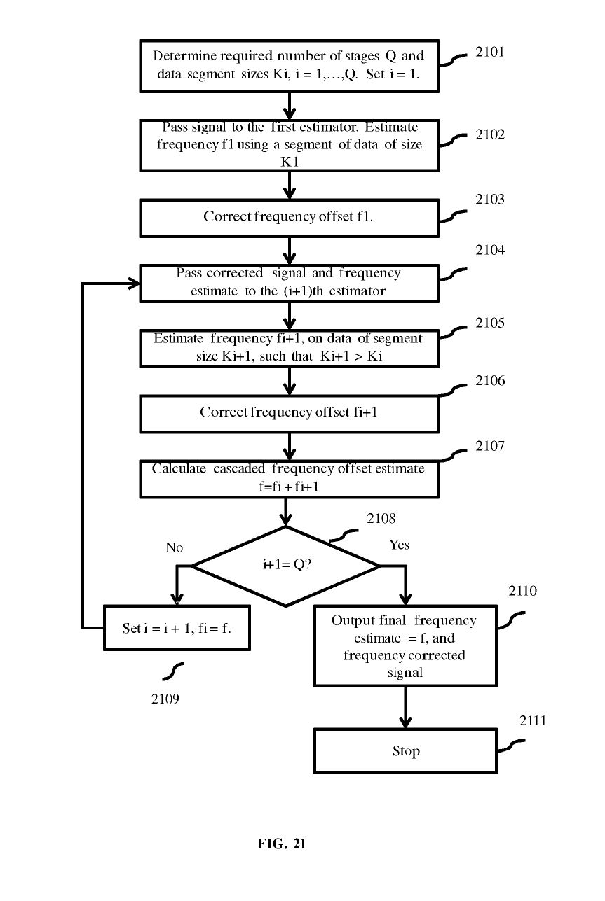

FIG. 21 is a flow chart illustrating the process of high accuracy, high range and low complexity frequency estimation, according to embodiments as disclosed herein. The required number of stages and the segment sizes for each stage may be determined (2101). Furthermore, in the i′^{th} stage, the i′^{th} frequency offset estimate (fᵢ) is obtained (2102) over a segment size of Kᵢ, where Kᵢ is determined based on the variance Vᵢ of frequency estimates and the estimation range Rᵢ when the estimation is done over a segment of size Kᵢ. The variance of the estimates increases with the segment size, and the range of estimation decreases with the segment size, i.e., V,ᵢ₊₁<Vᵢ iff Kᵢ>Kᵢ₊₁, and Rᵢ₊₁<Rᵢiff Kᵢ>Kᵢ₊₁. The variance Vᵢ is a measure of the expected error in the estimate of the i′^{th} stage. The frequency of the signal input to the i′^{th} stage may be corrected by the estimated frequency offset (fᵢ) of the i′^{th} stage (2103). After the correction, the output signal has some residual frequency offset due to the error in estimation which is related to Vᵢ. Kᵢ{i=1, . . . ,N} is selected such that the input signal to any stage has a frequency offset that lies within the estimation range of this stage with a high probability. The i′^{th} frequency offset estimate (fᵢ) as well as the frequency corrected signal may be passed (2104) to the next stage of frequency estimation. In the next stage, the frequency offset (fᵢ₊₁) may be estimated (2105), over a segment size of Kᵢ₊₁, where Kᵢ>Kᵢ₊₁, leading to a lower error in the estimate than in the i′^{th} stage. The frequency of the input signal to the i+1^{th} stage may be corrected by the estimated frequency offset value (fᵢ₊₁) (2106). The frequency estimated from the two stages may be added (2107) to get the cascaded frequency estimate (f=fᵢ+fᵢ₊₁).

The process checks (2110) if the required numbers of stages have been passed through (2108). Once the required numbers of stages have been passed through the process terminates (2111). The output from the cascaded frequency estimation and correction units comprises the frequency corrected signal and the final cascaded frequency estimate (2110). The various actions in the method 2100 may be performed in the order presented, in a different order or simultaneously. Further, in some embodiments, some actions listed in FIG. 21 may be omitted.

In an embodiment there are two stages of frequency estimation. Further, let the available sample size be ‘N’, the range of the conventional estimator over N samples be ‘R’ Hz and the variance of estimates be ‘V’. An estimator of range ‘KR’ may be required.

The first estimator may work over 1/K of the available samples, thereby enabling segments of size N/K samples. The range for the estimation may be R₁=KR. For this range, let the variance of estimates be V₁ and the estimated frequency offset be f₁. The frequency of the data may be corrected by frequency f₁. The corrected samples may be passed to the second estimator. The second estimator may work over a segment of size N. Let the estimated frequency for the second stage be f₂. The final cascaded estimate of frequency can be F=f₁+f₂.

If the error in the first estimate lies within the estimation range of the second estimator, then the cascading operation will not reduce accuracy of estimates from that of the second stage. i.e. if sqrt(V₁)<<R i.e., sqrt(V₁)<<R₁/K, then the cascaded estimate may be almost as accurate as the estimate of the second stage wherein variance may be close to V.

A value for V₁ or V can be found in the literature [Quinn, 1994]. Using this, it can be seen that the condition sqrt(V₁)<<R₁/ K, does indeed hold true for large N. The standard deviation of estimates is 0(N−3/2), while the range of the estimator is 0(N−1).

In an embodiment, the smallest value of sample size N for which the condition holds true may depend on the signal to noise ratio (SNR) and on the value of K. Hence, the maximum value of K may be determined by the SNR and the available sample size. The accuracy of the cascaded estimate may be close to the estimate of the final stage, if the aforementioned condition holds true for the values of N, K, M and SNR.

The frequency estimation done by using a conventional method which deploys quadratic interpolation between three Fourier coefficients, with a required range of MR Hz and with K=2, yields the frequency estimation with the complexity of about 2MN complex MACs whereas the aforementioned method yields the frequency estimation with the complexity of about 4N complex MACs, while providing the same accuracy and range of estimation.

The embodiments disclosed herein can be implemented through at least one software program running on at least one hardware device and performing network management functions to control the network elements. The network elements shown in FIGS. 1, 2, 5, 6, 8, 10, 12, 13, 14, 17, 18 and 19 include blocks which can be at least one of a hardware device, or a combination of hardware device and software module.

The embodiment disclosed herein provide methods and systems to enable customization of an application to enhance user experience on a computing device by having one or more resident client entities negotiate with one or more client execution entities or a server on aspects of the application that can be customized. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the embodiments herein may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for demodulation of a received signal in a receiver in a wireless communication network, said method comprising
obtaining maximum expected frequency offset of said received signal;
comparing said maximum expected frequency offset to a pre-defined threshold;
performing coherent demodulation on said received signal, if said maximum expected frequency offset is less than said threshold; and
performing non-coherent demodulation on said received signal, if said maximum expected frequency offset is greater than said accuracy threshold.

2. The method, as claimed in claim 1, wherein said maximum expected frequency offset depends on at least one of
accuracy of frequency estimation of said received signal; and
expected frequency drift of said received signal during the time elapsed from a previous good frequency estimate.

3. The method, as claimed in claim 2, wherein said time is the interval between received bursts, wherein said interval is due to at least one of
frame structure of signals in the network;
intermittent decoding failures; and
a hibernating system.

4. A method for demodulation of a received signal in a receiver in a wireless communication network, said method comprising
predicting the frequency drift that occurs between the time of reception of said received signal and the last good frequency estimate;
performing a frequency correction of said received signal using said predicted frequency drift; and
demodulating said received signal using coherent detection.

5. A method for demodulation of a received signal in a receiver in a wireless communication network, said method comprising
performing a block transform on said received signal;
obtaining the output of said transform
determining the most likely transmitted code word using Maximum Likelihood estimation;
performing frequency estimation using said code word as a reference signal;
correcting the frequency of said received signal using said frequency estimates;
performing phase estimation using said code word as a reference signal;
correcting the phase of said transformed signal using said phase estimates;
performing a soft output decoding of said phase corrected signal.

6. A method for demodulation of a received signal in a receiver in a wireless communication network, said method comprising
performing a block transform on said received signal;
obtaining the output of said transform ;
determining the most likely transmitted code word using Maximum Likelihood estimation;
performing frequency estimation using said code word as a reference signal;
correcting the frequency of said received signal using said frequency estimates;
performing phase estimation using said code word as a reference signal;
correcting the frequency and phase of said transformed signal using said frequency and phase estimates;
performing a soft output decoding of said phase corrected signal.

7. The method, as claimed in claim 5, wherein said phase estimation involves processing said received signal and said reference signal.

8. The method, as claimed in claim 5, wherein said frequency estimation involves processing said received signal and said reference signal.

9. The method, as claimed in claim 5, wherein said method further comprises performing a block transformation on said corrected signal.

10. A method for demodulation of a received signal in a receiver in a wireless communication network, said method comprising
performing non-coherent detection of said received signal;
performing frequency estimation and correction of said received signal;
performing phase estimation and correction of said received signal; and
performing coherent detection of said estimated and corrected signal.

11. The method, as claimed in claim 10, wherein performing frequency estimation and correction of said signal further comprises
converting soft bits from said detected signal to hard bits;
modulating said hard bits to form a re-modulated signal;
performing frequency estimation using said re-modulated signal as a reference; and
performing frequency correction of the received signal using said frequency estimation.

12. The method, as claimed in claim 11, wherein performing frequency estimation and correction of said signal further comprises
converting soft bits from said detected signal to hard bits;
decoding an outer code used on said hard bits;
encoding said hard bits to form a re-encoded signal;
modulating said re-encoded bits to form a re-modulated signal;
performing frequency estimation using said re-modulated signal as a reference; and
performing frequency correction of the received signal using said frequency estimation.

13. The method, as claimed in claim 11, wherein said frequency estimation involves processing said received signal and said re-modulated signal.

14. The method, as claimed in claim 10, wherein said phase estimation involves processing said received signal and said re-modulated signal.

15. The method, as claimed in claim 10, wherein said method further comprises
estimating the phase of said received signal; and
performing phase correction of said transformed signal using said phase estimate.

16. The method, as claimed in claim 10, wherein said method further comprises
estimating the phase of said received signal; and
performing frequency and phase correction of said transformed signal using said frequency and phase estimates.

17. A receiver in a wireless communication network, said receiver comprising at least one means configured for
obtaining the maximum expected frequency offset of a received signal;
comparing said maximum expected frequency offset to a pre-defined threshold;
performing coherent demodulation on said received signal, if said maximum expected frequency offset is less than said threshold; and
performing non-coherent demodulation on said received signal, if said maximum expected frequency offset is greater than said threshold.

18. A receiver in a wireless communication network, said receiver comprising at least one means configured for
predicting the frequency drift incurred between the time of reception of a received signal and the last good frequency estimate;
performing a frequency correction of said received signal using said predicted frequency drift; and
demodulating said received signal using coherent detection.

19. A receiver in a wireless communication network, said receiver comprising at least one means configured for
performing non-coherent detection of a received signal;
performing frequency estimation and correction of said received signal;
performing phase estimation and correction of said received signal; and
performing coherent detection of said corrected signal.

20. The receiver, as claimed in claim 19, wherein said receiver is further configured for performing frequency estimation and correction of said detected signal by performing steps of
converting soft bits from said detected signal to hard bits;
modulating said hard bits to form a re-modulated signal;
performing frequency estimation using said re-modulated signal as a reference; and
performing frequency correction of the received signal using said frequency estimate.

21. The receiver, as claimed in claim 20, wherein said receiver is further configured for performing said frequency estimation by processing said received signal and said modulated signal.

22. The receiver, as claimed in claim 19, wherein said receiver is further configured for
estimating phase of said received signal; and
performing phase correction of said transformed signal using said phase estimate.

23. A receiver in a wireless communication network, said receiver including a plurality of frequency estimation and correction modules, wherein said modules are cascaded.

24. The receiver, as claimed in claim 23, wherein said modules are arranged in increasing order of the segment size used for estimation.

25. The receiver, as claimed in claim 23, wherein segment sizes used in said modules are chosen based on preferred accuracy, complexity and estimation range of frequency estimation.
